(19) United States
(12) Patent Application Publication
(10) Pub. No.: US 2005/0077871 A1
(43) Pub. Date: Apr. 14, 2005

(54) Apparatus for providing battery power to a telecommunication system

(75) Inventors: Subhas C. Chalasani, Troy, MI (US); Roy J. Davis, Rowlett, TX (US); Roy Kuipers, Rockwall, TX (US); Patrick K. Ng, Plano, TX (US)

Correspondence Address: HITT GAINES P.C., P.O. BOX 832570, RICHARDSON, TX, 75083, US

(73) Assignee: Tyco Electronics Power Systems, Inc., A Nevada Corporation, Mesquite, TX (US)

(21) Appl. No.: 10/950,256

(22) Filed: Sep. 24, 2004

Related U.S. Application Data
(60) Provisional application No. 60/505,610, filed on Sep. 24, 2003.

(51) Int. Cl. H02J 7/00

(52) U.S. Cl. 320/114

(57) ABSTRACT

An apparatus for providing battery power to a telecommunication system having a plurality of components mounted in an equipment rack that presents a standard width for receiving the components. In one embodiment, the apparatus includes: (1) a housing configured for mounting above at least some of the plurality of components in the equipment rack and (2) at least one battery pack contained within the housing and consisting of sealed unit battery cells. In another embodiment, the apparatus includes: (1) a housing configured for mounting anywhere in the equipment rack and (2) at least one battery pack contained within the housing and consisting of sealed unit battery cells that employ lithium battery technology.

### CROSS-REFERENCE TO RELATED APPLICATION

The present application is related to and claims priority based on U.S. Provisional Patent Application Ser. No. 60/505,610, filed by Davis, et al., on Sep. 24, 2003, entitled “Apparatus for Providing Battery Power to a Telecommunication System,” commonly owned herewith and incorporated herein by reference.

### TECHNICAL FIELD OF THE INVENTION

The present invention is directed to electrical power sources, and especially to battery power sources for providing power to telecommunication systems.

### BACKGROUND OF THE INVENTION

It is common in the telecommunication industry to employ lead-acid batteries for providing reserve backup battery power. Typical installations of such lead-acid batteries are embodied in a plurality of battery cells externally connected in series to present or produce the desired system bus voltage, usually 48 volts direct current (DC). Additional pluralities of battery cells may be added in parallel to provide additional capacity and system reserve time. The lead-acid batteries employed are heavy, large and unwieldy. Lead-acid batteries require various levels of ventilation and spill containment to meet industry safety standards. Lead-acid batteries are generally installed on a shelf (usually a bottom shelf, to avoid damaging other equipment in the event of a leak or spill of electrolyte) in an equipment cabinet or in a separate battery cabinet and arranged to ensure that adequate ventilation and spill containment are provided. Location at the bottom of a cabinet is also driven by the weight of the batteries since they are generally the heaviest of the system components. Lead-acid batteries must be handled, stored, shipped and disposed of as hazardous material. Identifying a bad or degraded lead acid battery among a plurality of batteries connected together is difficult, often amounting to an art form in itself. Generally, external discharge equipment or conductance measurement devices must be utilized in the process to determine the weak or bad battery or batteries. Many telecommunication system installations requiring battery power are constrained in their design alternatives because they must accommodate the strict requirements involved in using lead-acid batteries.

A need exists for an apparatus for providing battery power to a telecommunication system that avoids having to meet requirements for hazardous material handling. A need exists for an apparatus for providing battery power to a telecommunication system that may be mounted freely in an equipment rack among other components. A need exists for an apparatus for providing battery power to a telecommunication system that may be integrated into the telecommunication system and may be controlled and monitored remotely by a system control apparatus in the telecommunication system. A need exists for an apparatus for providing battery power to a telecommunication system that is lightweight with improved energy density over lead-acid batteries. A need exists for an apparatus for providing battery power to a telecommunication system that provides interconnection for presenting a desired system bus voltage in a modular arrangement. A need exists for an apparatus for providing battery power to a telecommunication system that displays an indication of battery power state of operation for quick identification in the field.

### SUMMARY OF THE INVENTION

To address the above-discussed deficiencies of the prior art, the present invention provides an apparatus for providing battery power to a telecommunication system having a plurality of components mounted in an equipment rack that presents a standard width for receiving the components. In one embodiment, the apparatus includes: (1) a housing configured for mounting above at least some of the plurality of components in the equipment rack and (2) at least one battery pack contained within the housing and consisting of sealed unit battery cells.

In another embodiment, the apparatus includes: (1) a housing configured for mounting anywhere in the equipment rack and (2) at least one battery pack contained within the housing and consisting of sealed unit battery cells that employ lithium battery technology. For purposes of the present invention, “telecommunications” is defined as including voice communications and data communications.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic drawing of one embodiment of a telecommunication system employing an apparatus constructed according to the principles of the present invention;

FIG. 2 illustrates a perspective view of one embodiment of an apparatus constructed according to the principles of the present invention installed in a telecommunication equipment rack with other components; and

FIG. 3 illustrates a detail perspective view of one embodiment of an electrical connecting structure and securing projection constructed according to the principles of the present invention.

### DETAILED DESCRIPTION

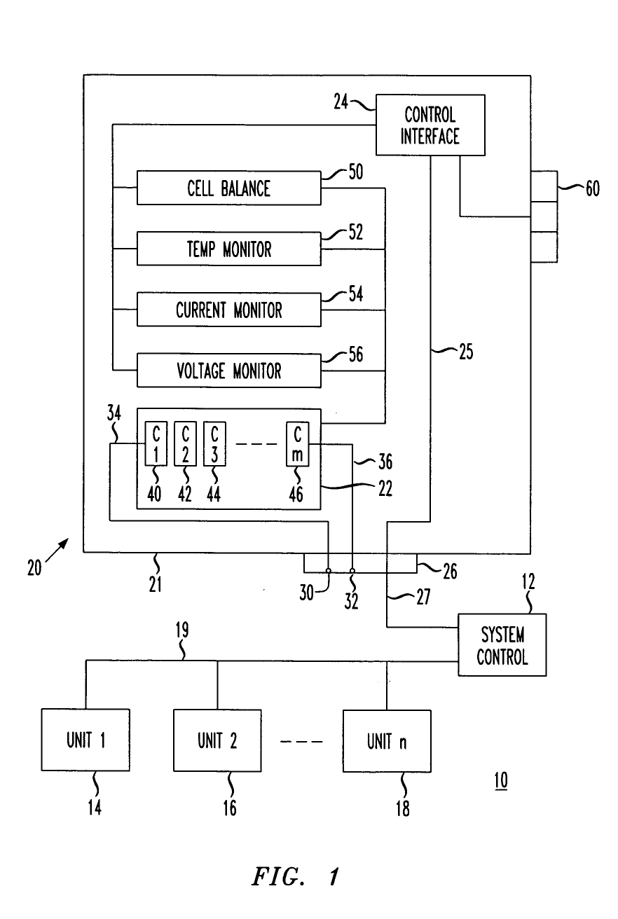

Referring initially to FIG. 1, illustrated is a schematic drawing of one embodiment of a telecommunication system employing an apparatus constructed according to the principles of the present invention. In FIG. 1, a telecommunication system 10 comprises a system control apparatus 12 and a plurality of system units 14 (“Unit 1”), 16 (“Unit 2”), 18 (“Unit n”). The system control apparatus 12 preferably also carries out monitoring functions regarding the operation of the telecommunication system 10. The indicator “n” is employed to signify that any number of units may be contained in the telecommunication system 10. The inclusion of the three units 14, 16, 18 in FIG. 1 is illustrative only and does not constitute any limitation regarding the number of units that may be included in the telecommunication system 10. The system control apparatus 12 is coupled with the units 14, 16, 18 via a control bus 19. Alternatively, the system control apparatus 12 may be independently coupled with each respective unit 14, 16, 18. Under most practical circumstances, the telecommunication system 10 is significantly more complex than illustrated in FIG. 1, but more detailed representation of telecommunication system 10 would not add to an understanding the present invention.

The telecommunication system 10 receives battery power at output loci 30, 32 from a battery power apparatus 20 that includes a housing 21. Details of connections between various portions of the telecommunication system 10 (e.g., the system control apparatus 12 and the units 14, 16, 18) and the output loci 30, 32 are not illustrated in detail in FIG. 1 to avoid making FIG. 1 more complex than it needs to be. The battery power apparatus 20 includes a battery pack 22 and a control interface device 24. The control interface device 24 is coupled via a control lead 25 with an electrical connecting structure 26 that traverses the housing 21. The system control apparatus 12 may be coupled via the electrical connecting structure 26 and a connecting lead 27 to the control interface device 24. Alternatively, the control bus 19 may be coupled with the electrical connecting structure 26 to effect coupling between the system control apparatus 12 and the control interface device 24. Connection with the electrical connecting structure 26 is advantageously carried out using a plug (not shown in FIG. 1). The control interface device 24 may be powered from the battery pack 22 (not shown in detail in FIG. 1) or from the system control apparatus 12 via the control lead 25 and the connecting lead 27. The control bus 19 connects to other controlled and monitored devices in telecommunication system 10 including, for example, system rectifiers (not shown in FIG. 1).

The battery pack 22 includes a plurality of battery cells 40 (cell C1), 42 (cell C2), 44, (cell C3), 46 (cell Cm). The indicator “m” is employed to signify that there can be any number of battery cells in the battery pack 22. The inclusion of four battery cells 40, 42, 44, 46 in FIG. 1 is illustrative only and does not constitute any limitation regarding the number of battery cells that may be included in the battery pack 22. The battery cells 40, 42, 44, 46 are electrically coupled in any combination of series or parallel connection (not shown in detail in FIG. 1) to ensure presenting a predetermined output voltage at output terminals 34, 36. It is preferred that the battery cells 40, 42, 44, 46 be sealed unit battery cells employing a dry technology and having a substantially uniform voltage output per cell. One technology that is particularly suitable for the battery cells 40, 42, 44, 46 is lithium battery technology, such as employed in lithium-ion batteries. The signals between the control interface device 24 and the system control apparatus 12 via the leads 25, 27 may be at voltages greater than, equal to or less than the predetermined output voltage presented at the output terminals 34, 36.

The output terminals 34, 36 are coupled with the output loci 30, 32 via the electrical connecting structure 26. The output terminals 34, 36 could alternatively be coupled with the output loci 30, 32 by another arrangement penetrating the housing 21 without involving the electrical connecting structure 26. In the illustrated embodiment, the electrical connecting structure 26 is integral, effecting all electrical and control connections from outside the housing 21 to components within the housing 21. The electrical connecting structure 26 advantageously effects connections using a plug connector for connections by electrical devices outside the housing 21 (not shown in FIG. 1) with connection the output loci 30, 32 and uses a plug connector for coupling the control lead 25 to the connecting lead 27. It is preferred that the electrical connecting structure 26 be embodied in a single connecting structure for all external connections with the battery power apparatus 20.

The battery power apparatus 20 preferably also includes a plurality of monitoring units 50 (which monitors cell balance), 52 (which monitors temperature), 54 (which monitors current), 56 (which monitors voltage). A greater or lesser number of monitoring units relating to a greater or lesser plurality of parameters may be employed. The monitoring units 50, 52, 54, 56 are representative only. The monitoring units 50, 52, 54, 56 are coupled with the battery pack 22 appropriately to carry out the intended monitoring. Thus, some monitoring units (e.g., the monitoring unit 50, which monitors cell balance) may be coupled with individual battery cells 40, 42, 44, 46 (not shown in detail in FIG. 1).

The monitoring units 50, 52, 54, 56 are also coupled with the control interface device 24. The control interface device 24 may be configured for carrying out some actions regarding the battery pack 22 that the monitoring units 50, 52, 54, 56 may indicate are necessary, thereby exercising some local control over the battery pack 22. The monitoring units 50, 52, 54, 56 may cooperate with the control interface device 24 to effect some control functions with respect to the battery pack 22. That is, the control interface device 24 may provide information from the monitoring units 50, 52, 54, 56 to the system control apparatus 12 and respond to orders from the system control apparatus 12 to effect changes in operation of the battery pack 22 in response to indications from the monitoring units 50, 52, 54, 56. Further, the control interface device 24 may provide information from the monitoring units 50, 52, 54, 56 to the system control apparatus 12 to actively change the operation of the DC power system rectifiers (not shown in FIG. 1) to optimize performance of the battery pack 22 in response to indications from the monitoring units 50, 52, 54, 56.

Configuring the battery power apparatus 20 for cooperation with the system control apparatus 12 (via the control interface device 24) advantageously provides an improved power supply arrangement having additional monitoring and control features that are more integrated into a host telecommunication system than is attainable by systems employing prior art technology. By way of example and not by way of limitation, such an improved integration with a host telecommunication system permits the battery power apparatus 20 to internally monitor and report charge and discharge currents to the system control apparatus 12. The integrated arrangement disclosed herein avoids requiring an external shunt or Hall Effect current monitoring transducer required by prior art systems. Reduced complexity, fewer system components, less space and less cost are often consequent results of the integrated arrangement embodiment of the present invention.

By way of example and not by way of limitation, the integrated arrangement permits the system control apparatus 12 to remotely monitor and gather data that is obtained manually in prior art power supply systems. Such data includes “inventory items” such as battery serial number, manufacture date, capacity rating, discharge rate, part number, model, type of technology, software version number used in the control interface device 24 and other data. Other data relating to operation of the battery power apparatus 20 may also be monitored and gathered such as, by way of example and not by way of limitation, operating temperature range, maximum discharge current, state of charge, time to full recharge, optimum float voltage, number of discharges, reserve time and other operational information.

The integrated system arrangement further permits the system control apparatus 12 to use monitored values received from the control interface device 24 dynamically to adjust DC voltage in the telecommunication system 10 to minimize current into the battery power apparatus 20.

A display unit 60 may be mounted for external viewing from outside the housing 21. The display unit 60 is coupled with the control interface device 24. The control interface device 24, the monitoring units 50, 52, 54, 56 and the display device 60 cooperate to indicate to an operator certain aspects of operation of the battery pack 22, such as state of charge, lack of power, capacity, loss of communication, failed battery and other parameters and conditions. Information provided by the display device 60 avoids the inconvenience of having to the open housing 21 and visually inspect the battery cells 40, 42, 44, 46 as is required, for example, in the case of lead-acid batteries when operators have to carry out maintenance actions. The display unit 60 may be embodied in any indicating structure, such as light- emitting diode (LED) indicators, dials, gauges or other visually indicative devices.

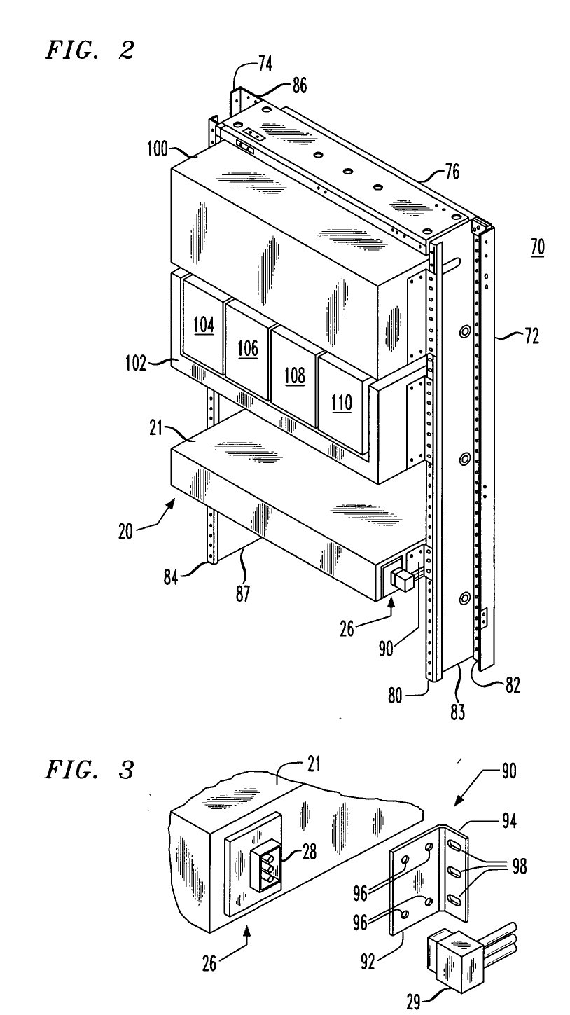

Turning now to FIG. 2, illustrated is a perspective view of one embodiment of an apparatus constructed according to the principles of the present invention installed in a telecommunication equipment rack with other components. In FIG. 2, an equipment rack assembly 70 includes vertical rails 72, 74 and a horizontal member 76. The vertical rail 72 is formed to present mounting sections 80, 82 facing in opposite directions depending from a central section 83. The vertical rail 74 is formed to present mounting sections 84, 86 facing in opposite directions depending from a central section 87. Each of the mounting sections 80, 82, 84, 86 has a plurality of spaced apertures (not individually indicated by an element number identifier) arrayed along its respective length. The battery power apparatus 20 includes a housing 21 that is configured to fit between the vertical rails 72, 74 and presents mounting brackets or securing projections 90 (only one securing projection 90 is visible in FIG. 2) for securing the battery power apparatus 20 to the equipment rack assembly 70. The securing projections 90 may be situated anywhere on the housing 21 to accommodate any mounting arrangement required by the rails 72, 74 or another rail or rack arrangement (not shown in FIG. 2).

The equipment rack assembly 70 is a standard rack configured for mounting other components thereto, such as a distribution apparatus 100 and an equipment shelf 102 holding system components 104, 106, 108, 110. The system components 104, 106, 108, 110 may embody the units 14, 16, 18 of FIG. 1. The battery power apparatus 20 is configured for mounting anywhere along the length of the rack assembly 70 so that the distribution apparatus 100, the equipment shelf 102 and the battery power apparatus 20 may be mounted to the rack assembly 70 in any order and in any combination. There is no need to require that a battery power apparatus be mounted at the bottom of the rack assembly 70 with sufficient space between the battery power apparatus 20 and the next adjacent component to permit ample ventilation for the battery power apparatus 20. Such requirements were a fact of design life when lead-acid batteries were used. No such mounting limitations apply to the apparatus of the present invention. Preferably, the housing 21 of the battery power apparatus 20 is an integer multiple of a standard height employed for designing other components for use in the rack assembly 70. For example, if a standard height unit for components is “U,” then it is preferred that housing 21 be (n×U), where n is an integer>0. Preferably battery power apparatus 20 presents a predetermined voltage output for use by other components in the telecommunication system 10. A plurality of the battery apparatus 20 may be affixed to the rack assembly 70 and connected in parallel or in series if another voltage is desired or if greater battery capacity is required.

The illustrated embodiment of the electrical connecting structure 26 is situated on one side of the housing 21 of the battery power apparatus 20 to facilitate easy access to the electrical connecting apparatus 26 by human operators.

Turning now to FIG. 3, illustrated is a detail perspective view of one embodiment of an electrical connecting structure and securing projection constructed according to the principles of the present invention. In FIG. 3, the housing 21 is traversed by the electrical connecting structure 26 to provide electrical access to interior portions of the housing 21. As mentioned earlier herein, it is preferred that the electrical connecting structure 26 is embodied in a plug connecting structure such as a plug arrangement having a female plug member 28 and a male plug portion 29 to facilitate use by human operators. Also illustrated in FIG. 3, in an exploded orientation with respect to the housing 21 is a mounting bracket or securing projection 90. The securing projection 90 is generally L-shaped having a first leg 92 with first apertures 96 for mounting the securing projection 90 to the housing 21, such as by welding, adhesive, threaded fasteners or another mounting arrangement. The securing projection 90 also has a second leg 94 with second apertures 98 for mounting the securing projection 90 to equipment rack assembly (FIG. 2), such as by using threaded fasteners within the second apertures 98 and apertures on the mounting sections 80, 84 (FIG. 2). The second apertures 98 are preferably arranged in the second leg 94 so that one or two of the second apertures 98 align for the mounting housing 21 to variously configured versions of the equipment rack assembly 70 having different aperture-spacing in their respective mounting sections 80, 84. By selecting such multiple-use spacing for the second apertures 98, one can use one version of the housing 21 to accommodate a plurality of designs of the rack assembly 70. Such multiple-use spacing thereby reduces inventory requirements for numbers of different models of the housing 21. Making fewer different models of the housing 21 lowers cost of manufacture to accommodate various models of the equipment rack 70.

Although the present invention has been described in detail, those skilled in the art should understand that they can make various changes, substitutions and alterations herein without departing from the spirit and scope of the invention in its broadest form.

1. An apparatus for providing battery power to a telecommunication system having a plurality of components mounted in an equipment rack that presents a standard width for receiving said components, comprising:
a housing configured for mounting above at least some of said plurality of components in said equipment rack; and
at least one battery pack contained within said housing and consisting of sealed unit battery cells.

2. The apparatus as recited in claim 1 wherein said sealed unit battery cells employ lithium battery technology.

3. The apparatus as recited in claim 1 wherein at least some of said plurality of components sit on shelves mounted within said equipment rack.

4. The apparatus as recited in claim 1 further comprising a control interface device contained within said housing and configured to control operation of said at least one battery pack.

5. The apparatus as recited in claim 2 wherein said housing permits connection by said at least one battery pack and said control interface device with said telecommunication system via an electrical connection structure traversing said housing.

6. The apparatus as recited in claim 2 wherein said control interface device monitors at least one selected from the group consisting of:
sealed unit battery cell balance,
sealed unit battery cell temperature,
sealed unit battery cell current, and
sealed unit battery cell voltage.

7. The apparatus as recited in claim 2 wherein said control interface device is configured to cooperate with a system control apparatus in said telecommunication system.

8. The apparatus as recited in claim 7 wherein said system control apparatus contains data selected from the group consisting of:
sealed unit battery cell serial number,
sealed unit battery cell manufacture date,
sealed unit battery cell capacity rating,
sealed unit battery cell discharge rate,
sealed unit battery cell part number,
sealed unit battery cell model, and
type of sealed unit battery cell technology.

9. The apparatus as recited in claim 7 wherein said system control apparatus monitors data selected from the group consisting of:
sealed unit battery cell operating temperature range,
sealed unit battery cell maximum discharge current,
sealed unit battery cell state of charge,
sealed unit battery cell time to full recharge,
sealed unit battery cell optimum float voltage,
sealed unit battery cell number of discharges, and
sealed unit battery cell reserve time.

10. The apparatus as recited in claim 1 wherein said at least one battery pack presents a predetermined voltage output.

11. An apparatus for providing battery power to a telecommunication system having a plurality of components mounted in an equipment rack that presents a standard width for receiving said components, comprising:
a housing configured for mounting in said equipment rack; and
at least one battery pack contained within said housing and consisting of sealed unit battery cells that employ lithium battery technology.

12. The apparatus as recited in claim 11 wherein said sealed unit battery cells are lithium ion batteries.

13. The apparatus as recited in claim 11 wherein at least some of said plurality of components sit on shelves mounted within said equipment rack.

14. The apparatus as recited in claim 11 further comprising a control interface device contained within said housing and configured to control operation of said at least one battery pack.

15. The apparatus as recited in claim 12 wherein said housing permits connection by said at least one battery pack and said control interface device with said telecommunication system via an electrical connection structure traversing said housing.

16. The apparatus as recited in claim 12 wherein said control interface device monitors at least one selected from the group consisting of:
sealed unit battery cell balance,
sealed unit battery cell temperature,
sealed unit battery cell current, and
sealed unit battery cell voltage.

17. The apparatus as recited in claim 12 wherein said control interface device is configured to cooperate with a system control apparatus in said telecommunication system.

18. The apparatus as recited in claim 17 wherein said system control apparatus contains data selected from the group consisting of:
sealed unit battery cell serial number,
sealed unit battery cell manufacture date,
sealed unit battery cell capacity rating,
sealed unit battery cell discharge rate,
sealed unit battery cell part number,
sealed unit battery cell model, and
type of sealed unit battery cell technology.

19. The apparatus as recited in claim 17 wherein said system control apparatus monitors data selected from the group consisting of:
sealed unit battery cell operating temperature range,
sealed unit battery cell maximum discharge current,
sealed unit battery cell state of charge,
sealed unit battery cell time to full recharge,
sealed unit battery cell optimum float voltage,
sealed unit battery cell number of discharges, and
sealed unit battery cell reserve time.

20. The apparatus as recited in claim 11 wherein said at least one battery pack presents a predetermined voltage output.
